(19) United States
(12) Patent Application Publication
(10) Pub. No.: US 2021/0259238 A1
(43) Pub. Date: Aug. 26, 2021

(54) HUNTING DEVICE

(71) Applicant: KELLY WHITE, DES MOINES, IA (US)

(72) Inventor: KELLY WHITE, DES MOINES, IA (US)

(21) Appl. No.: 17/247,595

(22) Filed: Dec. 17, 2020

Related U.S. Application Data
(60) Provisional application No. 62/979,550, filed on Feb. 21, 2020.

(51) Int. Cl. A01M 31/06; F16M 11/38

(52) U.S. Cl. CPC A01M 31/06; F16M 2200/041; F16M 11/38

(57) ABSTRACT

While hunting or birdwatching, a user is able to deploy a male decoy remotely from a blind after the sole use of the female decoy has failed to attract the target animal. The device for luring the target animal towards a location includes a substantially planar fan which is kept in a concealed position until a mechanism releases a biasing element configured to prevent the decoy from inadvertently moving out of the concealed position, thereby allowing the decoy to move into the deployed position.

### CROSS REFERENCE TO RELATED APPLICATIONS

This application claims priority under 35 U.S.C. § 119 to provisional patent application U.S. Ser. No. 62/979,550, filed Feb. 21, 2020. The provisional patent application is herein incorporated by reference in its entirety, including without limitation, the specification, claims, and abstract, as well as any figures, tables, appendices, or drawings thereof.

### FIELD OF THE INVENTION

The present invention relates generally to a device that aids in luring animals towards a desired location and a corresponding method of use. More particularly, but not exclusively, the present invention relates to a male decoy which can be deployed remotely from a blind and used in combination with a female decoy after the sole use of the female decoy has failed to attract the target animal.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Calling in a turkey is an essential part of turkey hunting. It is advantageous to get the turkey as close as possible before attempting to kill the turkey, especially if one is hunting the turkeys with a bow. Due to the turkeys' incredible eyesight, turkey hunters are often frustrated with how best to lure in a turkey while not being seen. Some turkey hunters use turkeys calls or stuffed turkey decoys to lure in male turkeys (known as gobblers or toms) looking to mate or to fight. It is important to note turkeys are extremely territorial birds.

While these methods known in the art are sometimes effective, often times it is impossible to tell whether a tom is more interested in fighting or mating. For example, a turkey hunter may find that for whatever reason, a decoy which impersonates a hen is unable to lure in the tom. In such a situation, the turkey hunter would like to switch the hen decoy for a strutter (a decoy which impersonates another tom trespassing within the territory of the target bird) without being seen and scaring the tom.

Thus, there exists a need in the art for a device which has the capacity to attract an animal regardless of whether the animal is looking to fight or mate and one which can be employed from a remote location, such as from a blind.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

It is a further object, feature, and/or advantage of the present invention to employ use of a realistic looking decoy so as not to needlessly scare off a target animal.

It is still yet a further object, feature, and/or advantage of the present invention to provide a device which can be actuated with both mechanical and electrical means.

The hunting device disclosed herein can be used in a wide variety of applications, including at least turkey hunting, the hunting of other territorial or sight dominant animals, bird watching, and wildlife viewing.

It is preferred the apparatus be safe, cost effective, and durable. For example, the device should comply with any laws and regulations which apply to the intended use of the device (e.g., hunting, bird watching, wildlife viewing, etc.). The device is also substantially weatherproof.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the present invention.

Methods can be practiced which facilitate use, manufacture, assembly, maintenance, and repair of a device which accomplish some or all of the previously stated objectives.

The hunting device can be incorporated into systems which accomplish some or all of the previously stated objectives.

According to some aspects of the present disclosure, a device for luring a target animal towards a location comprises a decoy having a concealed position and a deployed position, a biasing element to prevent the decoy from moving out of the concealed position, and a mechanism configured to release the biasing element from a remote location, thereby allowing the decoy to move from the concealed position to the deployed position.

According to some additional aspects of the present disclosure, the decoy includes a fan to visibly attract the target animal when the decoy is in the deployed position.

According to some additional aspects of the present disclosure, the decoy further includes a frame which allows for adjustment of the fan in an angular or a translational direction.

According to some additional aspects of the present disclosure, wherein the frame is attached to the fan via wingnuts.

According to some additional aspects of the present disclosure, the device further comprises a mounting assembly to secure the device to a fixed object.

According to some additional aspects of the present disclosure, the biasing element is attached to the mounting assembly.

According to some additional aspects of the present disclosure, the biasing element is a spring.

According to some additional aspects of the present disclosure, the mechanism includes a string, a wire, or a rope.

According to some additional aspects of the present disclosure, the mechanism is free of electronics.

According to some additional aspects of the present disclosure, the mechanism is an electronic remote control.

According to some additional aspects of the present disclosure, the decoy comprises camouflage to keep the decoy from being seen when the decoy is in the concealed position.

According to some other aspects of the present disclosure, a system for luring a target animal towards a location comprises a first decoy appearing to be a first sex of the target animal species, a second decoy appearing to be a second sex of the target animal species having a concealed position and a deployed position, a biasing element to prevent the second decoy from moving out of the concealed position, and a mechanism configured to release the biasing element from a remote location, thereby allowing the second decoy to move from the concealed position to the deployed position.

According to some additional aspects of the present disclosure, the first decoy preserves at least a portion of a carcass.

According to some additional aspects of the present disclosure, the first decoy is a stuffed bird.

According to some additional aspects of the present disclosure, the first decoy is a deer mount.

According to some additional aspects of the present disclosure, the first sex is female and the second sex is male.

According to some additional aspects of the present disclosure, the first sex is male and the second sex is female.

According to some other aspects of the present disclosure, a method of luring a target animal towards a location comprises placing a first decoy appearing to be a first sex of the target animal species such that the first decoy can be seen by the target animal, concealing a second decoy appearing to be a second sex of the target animal species, and after failing to initially lure the target animal towards the location with the first decoy, deploying the second decoy from a remote location such that the second decoy can be seen by the target animal.

According to some additional aspects of the present disclosure, the method further comprises killing the target animal after deploying the second decoy with a ranged weapon.

According to some additional aspects of the present disclosure, the method further comprises using a game call to aid in luring the target animal towards the location.

According to some additional aspects of the present disclosure, the location is a field.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 shows an upper perspective view of a hunting device in a deployed position.

FIG. 2 shows a side perspective view of the hunting device of FIG. 1.

FIG. 3 shows a rear perspective view of the mounting assembly and the deployment assembly of the hunting device of FIG. 1.

FIG. 4 shows a detailed and lower perspective view of an exemplary decoy design of the hunting device of FIG. 1.

FIG. 5 shows a mechanical control for deploying the device of FIG. 1.

An artisan of ordinary skill need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

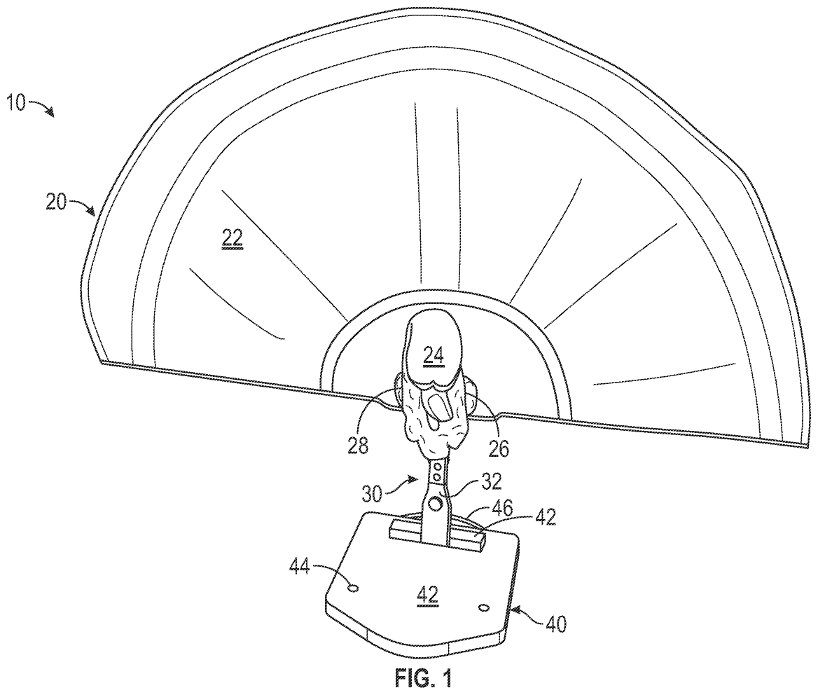

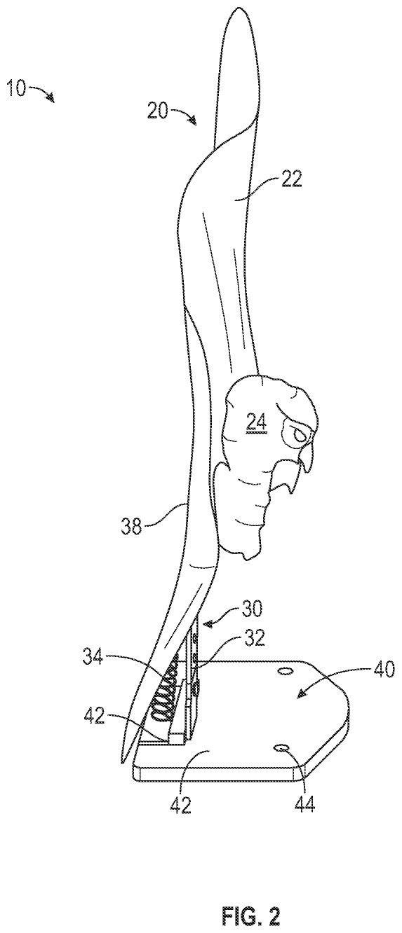

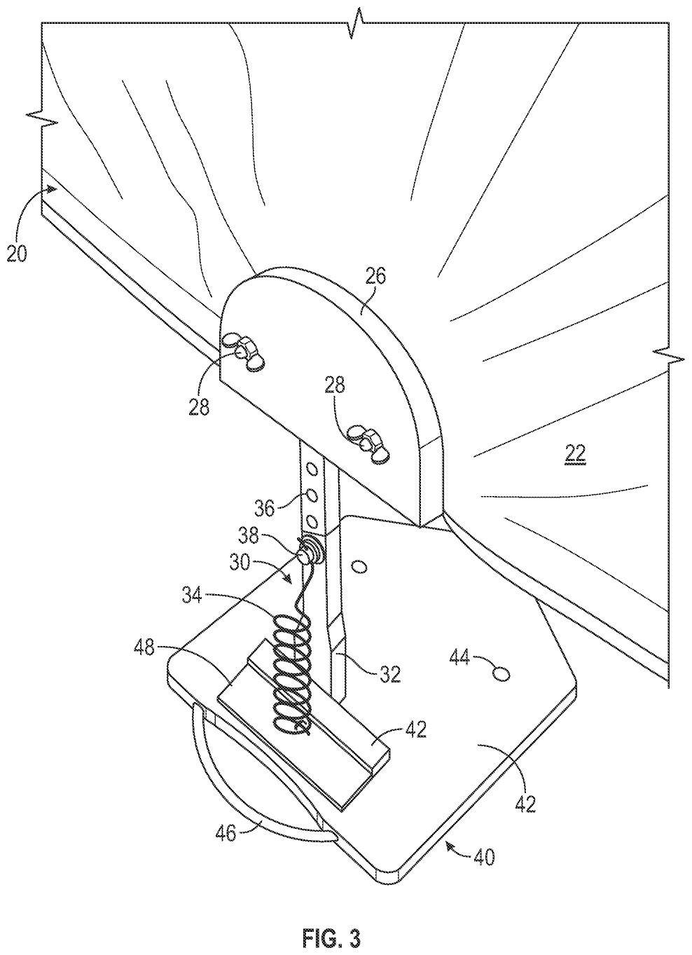

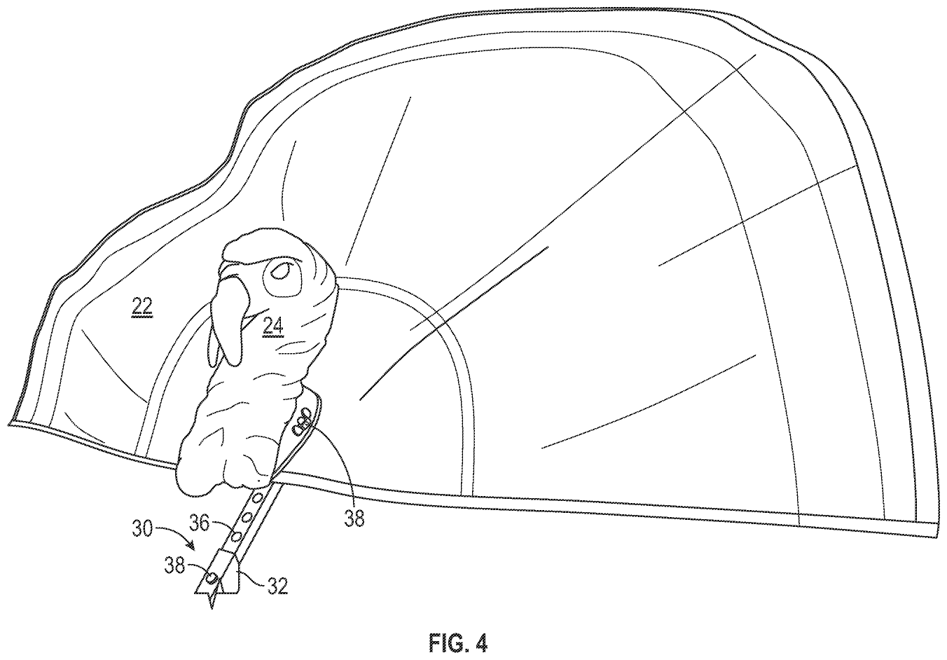

Referring now to FIGS. 1-4, a device 10 for luring a target animal towards a location comprises a decoy 20, a deployment assembly 30, a mounting assembly 40, and a deployment mechanism 50.

The decoy 20 shown in FIGS. 1-4 movable between a concealed position and a deployed position.

In the concealed position, the decoy 20 is preferably hidden from the eyesight of the target animal due to the collapsible nature of the device 20. For example, the device 20 may collapse so that the device 20 is substantially contained within two dimensions. In such a configuration, device 20 could lie underneath grass, brush, or another suitable environmental structure. In another such configuration, the decoy 20 is colored such that it blends in with a background surface. In yet another such configuration, the decoy 20 comprises camouflage to keep the decoy 20 from being seen when the decoy 20 is in the concealed position.

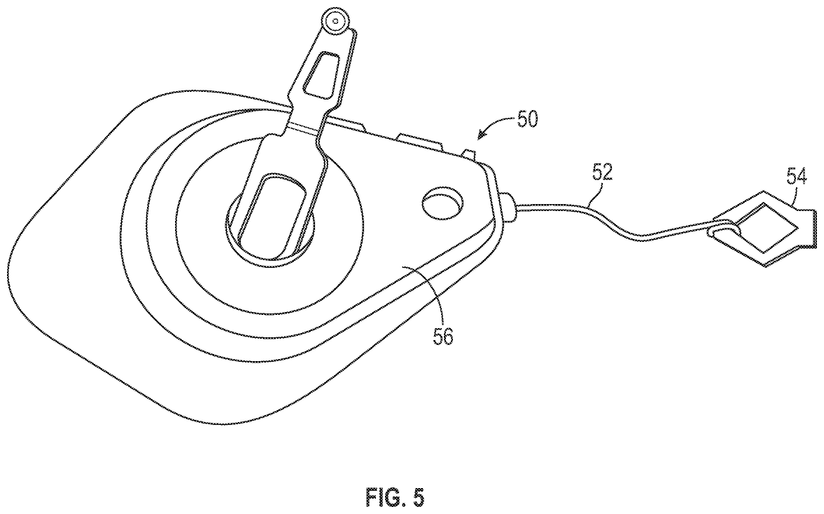

Movement from the concealed position to the deployed position is typically caused by a mechanism (e.g., the deployment mechanism 50 of FIG. 5) configured to release a biasing element 34 of a deployment assembly 30 from a remote location, such as a blind. In one embodiment, the decoy 20 is at substantially right angle (i.e., about 90 degrees) with respect to a fixed object (i.e., the ground) in the deployed position.

While the decoy 20 shown in the drawings is movable a concealed position and a deployed position, this is not meant to be limiting on the claimed invention, unless specified within the claims. For example, an alternative embodiment of the present invention could include a stationary decoy which is concealed by a foreign object (the concealed position) until the foreign object is moved, thereby revealing the decoy 20 (the deployed position).

The decoy 20 typically comprises a fan 22 to visibly attract the target animal when the decoy is in the deployed position. A head 24 may be included to make the decoy 20 look as realistic as possible. Certain aspects of the head 24 and fan 22 may be purely aesthetic, while other aspects are specifically included due to their effectiveness to attract the target animal.

These aspects of the decoy 20 can vary depending on what species the target animal is (e.g., turkeys or deer), what the sex of the target animal is (e.g. male or female), or even the size of the target animal (e.g. large or small animals). For example, when trying to encourage a target tom to fight with the decoy 20 imitating the same sex as the target animal, a jake turkey decoy may be utilized which includes a fan that is lankier and a head which includes a short beard. This encourages the target tom to protect his territory. On the other hand, if the tom is too passive and is intimidated by the decoy 20, the tom may be scared away.

It is to be appreciated the decoy 20 may comprise a combination of any known three-dimensional shapes, such as cylinders, ellipsoids (including spheres) or partial ellipsoids (including hemispheres), regular polyhedrons (including pyramids, cubes, etc.), irregular polyhedrons, cones, surfaces of revolution (including tori), helixes (e.g., coils and springs), etc. The decoy 20 may be solid, partially hollow, or completely hollow. The decoy 20 is preferably colored to best suit its intended use. Furthermore, surfaces of the fan 22 may take any known two-dimensional shape, such as ovals (including ellipses, circles, etc.), partial ellipses (including semicircles), stadiums, regular polygons (including triangles, rectangles, etc.), irregular polygons, cones, shapes of letters or numbers, curves and splines extruded in two dimensions, or a combination of any of the preceding two-dimensional shapes.

The fan 22 and the head 24 are preferably attached to a frame 26 which allows for adjustment of the fan 22 in an angular or a translational direction. The adjustment of the fan 22 may be accomplished through the use of an adjustable support member for the frame 32. The translational direction may be any translation direction, such as lateral, vertical, diagonal, etc. The frame 26 may be configured such that the adjustment of the fan 22 may occur before the decoy 20 is set up or after the decoy 20 moves from the concealed position to the deployed position.

In such embodiments, a means for attaching 28 the fan 22 and the head 24 to the frame 26 of the decoy 20 may comprise screws, nuts, bolts, pins, rivets, staples, clecos, washers, grommets, latches, clamps, lobster clasps, flanges, ties, adhesives, buttons, frogs, zippers, buckles, hook and look fasteners, any other known fastening mechanisms, or any combination thereof may be used to facilitate fastening. In the embodiment shown in FIGS. 1-4, wingnuts are utilized.

As briefly mentioned previously, a biasing element 34 is used to prevent the decoy 20 from moving out of the concealed position until an input is received from a user. However, the present disclosure also contemplates the biasing element being configured such that it prevents the decoy 20 from moving out of the deployed position, or even that the biasing element 34 holds a foreign object in place until released. While the biasing element 34 is shown in FIGS. 1-4 as a spring, the biasing element may also comprise any other type elastic object, a mechanically, pneumatically, hydraulically, or electronically driven actuator which is actuatable in response to a user input, a gravitational force, or any other known means for facilitating bias.

The mounting assembly 40 secures the device 10 (including the decoy 20, the deployment assembly 30, and potentially even a portion of the mechanism 50) to a fixed object, such as the ground, a tree, or any other device capable of supporting the weight of the device. The mounting assembly 40 may be attached directly to the frame 26, the adjustable support member of the frame 32, the biasing mechanism 34, or a combination of any of the preceding elements via an attachment means 38 and apertures 36 of the deployment assembly. The attachment means 38 of the deployment assembly are preferably some combination of nuts bolts, and washers; however, the attachment means 38 may also be any other known means which facilitate fastening.

As shown in FIGS. 1-4, the mounting assembly 40 can include a base 42 having apertures 44 and an attachment means 48 for attaching the mounting assembly to the fixed object. The base 42 may be formed from sheet metal cut into any known, desired shape. The weight of the base 42 helps keep the device 10 in place during use. In a preferred embodiment, the attachment means 48 are stakes or screws which pass through the apertures 44 in the base 42 and into the fixed object; however, the attachment means 48 of the mounting assembly may comprise any known means which facilitate fastening.

The mounting assembly 40 may also include a handle 46 at the rear of the base 42 so that the device 10 may be easily carried by the user while not in use. The handle 46 may comprise any material which assists the user in gripping the tool, such as knurling, specially shaped grooves, partially adhesive substances, any other materials known gripping mechanisms, or any combination thereof.

As mentioned previously, a mechanism 50 may be configured to release the biasing element from a remote location, thereby allowing the decoy to move from the concealed position to the deployed position. FIG. 5 shows such an exemplary deployment mechanism 50, which is free from the use of electronics. Being free from the use of electronics allows the device 10 to be used in as many potential jurisdictions as possible, given that some jurisdictions and government agencies which regulate hunting do not permit the use of or permit very little use of electronic devices while hunting for environmental or ethical considerations.

The mechanism shown in FIG. 5 includes a string, a wire, or a rope 52, a latch 54 to trigger the biasing mechanism 34, and a portable body 56 which can be held by a user from the remote location. In another embodiment, the portable body 56 is specifically designed so that the user can use the mechanism 50 without the use of their hands so that their hands remain free to accomplish other tasks, such as holding a bow. In yet another embodiment, and so long as the local authority which regulates hunting or wildlife watching permits, the mechanism is an electronic remote control.

The device 10 according to at least some of the aspects above may be incorporated into a system for luring a target animal towards a location. More particularly, the system may include a first decoy appearing to be a first sex of the target animal species and a second decoy appearing to be a second sex of the target animal species having a concealed position and a deployed position. The first decoy may preserve at least a portion of a carcass to improve the realistic look of the first decoy. The first decoy may be a stuffed bird (e.g. turkey), a deer mount, or remains of other animals which rely heavily on their eyesight. While the first decoy typically imitates the look of a female of the target animal species and the second decoy typically imitates the look of a male of the target animal species, the sexes could be reversed, or could even be identical among the first and second decoy.

The system preferably utilizes a biasing element to prevent the second decoy from moving out of the concealed position and a mechanism configured to release the biasing element from a remote location, thereby allowing the second decoy to move from the concealed position to the deployed position.

Finally, it is to be appreciated to lure a target animal towards a desired location, it may be necessary for one to place the first decoy such that the first decoy can be seen by the target animal, conceal the second decoy, and after failing to initially lure the target animal towards the location with the first decoy, deploy the second decoy from a remote location such that the second decoy can be seen by the target animal. The present disclosure also contemplates the use of game calls in combination with the device 10 to aid in luring the target animal towards the location.

For example, the first decoy may be place in an open field while the second decoy is placed underneath some brush within the field. After the first decoy fails to lure in the target animal, a user may trigger the mechanism in order to deploy the second decoy in a further attempt to lure in the target animal. This allows the hunter the best chance to more easily kill the target animal with a ranged weapon, such as a bow or a shotgun.

From the foregoing, it can be seen that the present invention accomplishes at least all of the stated objectives.

### LIST OF REFERENCE CHARACTERS

The following reference characters and descriptors are not exhaustive, nor limiting, and include reasonable equivalents. If possible, elements identified by a reference character below and/or those elements which are near ubiquitous within the art can replace or supplement any element identified by another reference character.

10 device

20 decoy

22 fan

24 head

26 frame

28 attachment means of decoy (e.g., wingnuts)

30 deployment assembly

32 adjustable support member for frame

34 biasing element (e.g., spring)

36 apertures in deployment assembly

38 attachment means of deployment assembly (e.g., nuts, bolts, washers)

40 mounting assembly

42 base (including base plate)

44 apertures in mounting assembly

46 handle

48 attachment means of mounting assembly (e.g., stakes, screws)

50 deployment mechanism

52 string, wire, or rope

54 latch

56 portable body

### GLOSSARY

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

What is claimed is:

1. A device for luring a target animal towards a location comprising:
a base including apertures through which the device can be mounted to fixed objects;
a decoy with a substantially planar fan hingedly connected to the base, said decoy having a concealed position wherein the substantially planar fan is substantially parallel with the base and a deployed position;
a biasing element to prevent the decoy from inadvertently moving out of the concealed position; and
an actuatable mechanism configured to release the biasing element from a remote location, thereby allowing the decoy to move from the concealed position to the deployed position.

2. The device of claim 1 wherein the fan includes bright colors to visibly attract the target animal when the decoy is in the deployed position.

3. The device of claim 2 wherein the decoy further includes a frame which allows for adjustment of the fan in an angular or a translational direction.

4. The device of claim 3 wherein the frame is attached to the fan via wingnuts.

5. The device of claim 1 further comprising a handle for carrying the device.

6. The device of claim 1 wherein the biasing element is attached to the base.

7. The device of claim 1 wherein the biasing element comprises a spring.

8. The device of claim 1 wherein the actuatable mechanism includes a string, a wire, or a rope.

9. The device of claim 1 wherein the actuatable mechanism is controlled by an electronic remote control.

10. The device of claim 1 wherein the decoy is substantially weatherproof and comprises camouflage to keep the decoy from being seen when the decoy is in the concealed position.

11. A system for luring a target animal towards a location comprising:
a first decoy appearing to be a first sex of the target animal species;
a second decoy appearing to be a second sex of the target animal species having a concealed position and a deployed position;
a biasing element to prevent the second decoy from moving out of the concealed position; and
a mechanism configured to release the biasing element from a remote location, thereby allowing the second decoy to move from the concealed position to the deployed position.

12. The system of claim 11 wherein the first decoy preserves at least a portion of a carcass.

13. The system of claim 12 wherein the first decoy is a stuffed bird.

14. The system of claim 12 wherein the first decoy is a deer mount.

15. The system of claim 11 wherein the first sex is female and the second sex is male.

16. The system of claim 11 wherein the first sex is male and the second sex is female.

17. A method of luring a target animal towards a location comprising:
placing a first decoy appearing to be a first sex of the target animal species such that the first decoy can be seen by the target animal;
concealing a second decoy appearing to be a second sex of the target animal species; and
after failing to initially lure the target animal towards the location with the first decoy, deploying the second decoy from a remote location such that the second decoy can be seen by the target animal.

18. The method of claim 17 further comprising killing the target animal after deploying the second decoy with a ranged weapon.

19. The method of claim 17 further comprising using a game call to aid in luring the target animal towards the location.

20. The method of claim 17 wherein the location is a field.
